(19) United States
(12) Patent Application Publication
(10) Pub. No.: US 2025/0169639 A1
(43) Pub. Date: May 29, 2025

(54) Device for Feeding Coffee Powder into a Brewing Chamber of a Coffee Machine

(71) Applicant: Eversys Holding SA, Ardon (CH)

(72) Inventors: Grégoire LOCHER, Daillon (CH); Stéphane BÉTRISEY, Charrat (CH)

(21) Appl. No.: 18/974,268

(22) Filed: Dec. 9, 2024

Related U.S. Application Data
(63) Continuation of application No. 17/414,796, filed on Jun. 16, 2021, now Pat. No. 12,161,248.

(30) Foreign Application Priority Data
Dec. 21, 2018 (DE) 20 2018 107 372.9

(51) Int. Cl. A47J 31/06; A47J 31/36; A47J 31/40; A47J 31/42; A47J 31/52

(52) U.S. Cl. CPC A47J 31/0663; A47J 31/3609; A47J 31/404; A47J 31/42; A47J 31/52

(57) ABSTRACT

In a device for feeding coffee powder into a brewing chamber of a coffee machine, the brewing chamber comprises a brewing chamber container (1) having a filling opening (2) for receiving the coffee powder (a) and a feeding apparatus (3) for feeding the coffee powder into the brewing chamber container through the filling opening (2). By means of a shaking apparatus (4), the coffee powder fed into the brewing chamber is levelled. Thereby, the coffee powder is prevented from piling up in the form of hills during the coffee powder is filled into the brewing chamber.

### CROSS-REFERENCE TO RELATED APPLICATIONS

The present application is a continuation of currently pending U.S. patent application Ser. No. 17/414,796, filed on Jun. 16, 2021, entitled “Device for Feeding Coffee Powder into a Brewing Chamber of a Coffee Machine,” which is a national-phase filing under Section 371 of International Application PCT/EP2019/078812, filed on Oct. 23, 2019, which claims the benefit of and priority to German application DE 20 2018 107 372.9, filed on Dec. 21, 2018; each of which is incorporated herein in its entirety.

### TECHNICAL FIELD

Examples set forth in the present disclosure relate to a device for feeding coffee powder into a brewing chamber of a coffee machine and to a brewing chamber for a coffee machine.

### BACKGROUND

The quality of coffee beverages produced in fully automatic or semi-automatic coffee machines by brewing coffee powder with hot water substantially depends on, inter alia, the distribution, the homogeneity and the density of the coffee powder introduced into a brewing chamber of the coffee machine, as well as many other parameters. The coffee powder is produced in fully automatic or semi-automatic coffee machines either by an integrated grinding device or is provided in a storage container for already pre-ground coffee powder and transported into the brewing chamber in portions during the production of a coffee beverage, compressed therein if appropriate, and brewed with hot water to produce the coffee beverage.

### SUMMARY OF THE INVENTION

When the coffee powder ground in a grinding device of the coffee machine or provided in the storage container is fed into the brewing chamber, the problem arises that, when the coffee powder is introduced into a brewing chamber container, there is no even leveling of the coffee powder introduced into the brewing chamber container. Due to gravity, the coffee powder falls from above through a filling opening into the brewing chamber container and forms an unevenly shaped heap of coffee powder in the form of a hill there. In particular, when espresso is produced, the coffee powder in the brewing chamber container is compressed by mechanical pressure, wherein the pressure is applied either manually outside the coffee machine by a barista using a tamper or automatically inside the coffee machine by a tamper being pressed from above through the filling opening into the brewing chamber container to compress the coffee powder. The pressure applied in the process likewise has a considerable influence on the quality of the coffee beverage produced. Due to the accumulation of the coffee powder in the form of a hill during introduction into the brewing chamber container, an uneven distribution of the coffee powder in the brewing chamber container and, when the coffee powder is pressed, an inhomogeneous density distribution of the coffee powder compressed in the brewing chamber container are resulting. This has adverse effects on the quality of the coffee beverage produced.

In order to overcome this problem, apparatuses for introducing and distributing coffee powder into brewing chamber containers of coffee machines have been proposed in the prior art, with which an evenly filling of the brewing chamber container is made possible. For example, EP 3 400 853 A1 discloses a device for introducing and evenly distributing coffee powder into a portafilter container of an espresso machine, the device comprising a rotor which is rotatably mounted in the portafilter container and has rotor blades arranged thereon. The rotor blades are inclined in relation to the rotational axis of the rotor. During the introduction of coffee powder into the portafilter container, the rotor is caused to rotate, as a result of which the rotor moves upward and the introduced amount of coffee powder is mixed evenly.

However, this device known from the prior art for introducing and distributing coffee powder into a brewing chamber container of a coffee machine proves to be disadvantageous because the amount of coffee powder introduced into the brewing chamber container cannot be compressed by a tamper, which can be inserted from above into the filling opening of the brewing chamber container, because a lid is arranged in the region of the filling opening on the portafilter container, in which the rotor is rotatably mounted. The coffee powder introduced into the portafilter container by means of the device known from the prior art therefore cannot be compressed automatically through inside the coffee machine by using an integrated tamper in the brewing chamber container.

Proceeding therefrom, it is an object of the invention to provide a device for feeding coffee powder into a brewing chamber of a coffee machine, which device on the one hand allows the coffee powder to be distributed as evenly and homogeneously as possible in the brewing chamber and on the other hand allows the introduced coffee powder to be compressed by the action of a tamper integrated in the coffee machine.

The device for feeding coffee powder into a brewing chamber of a coffee machine comprises a brewing chamber container with a filling opening and a feeding apparatus for feeding the coffee powder through the filling opening into the brewing chamber, which is used for receiving and brewing the coffee powder. In order to even out the coffee powder introduced into the brewing chamber by means of the feeding apparatus, the device comprises a shaking apparatus which is coupled to the brewing chamber in order to cause it to vibrate, while the coffee powder is fed or after the coffee powder has been fed from the feeding apparatus into the brewing chamber.

The shaking apparatus coupled to the brewing chamber container causes the brewing chamber to vibrate during the introduction of the coffee powder into the brewing chamber container or after completion of the filling process. Due to the vibration of the brewing chamber, the amount of coffee powder introduced therein is distributed evenly in the brewing chamber during or after the filling process, without a heap of coffee powder in the form of a hill being able to form in the brewing chamber. After completion of the introduction of the coffee powder into the brewing chamber and the evening out of the distribution of the introduced coffee powder, the shaking apparatus can be switched off, and the introduced amount of coffee powder can be compressed with a tamper which is pressed into the brewing chamber container through the filling opening. The tamper is expediently an integral component of the coffee machine so that the introduced coffee powder can be compressed in an automated manner within the coffee machine.

In order to ensure that the entire amount of coffee powder transported from the feeding apparatus to the brewing chamber enters the brewing chamber, it is expedient to equip the feeding apparatus with a feeding element decoupled from the brewing chamber container. The coffee powder can thereby be conducted largely without loss from the feeding apparatus into the brewing chamber container of the brewing chamber. The feeding element can be, for example, a funnel or a filling tube. The feeding element is expediently arranged above the filling opening of the brewing chamber container so that the coffee powder can fall from a discharge opening of the feeding element into the brewing chamber container due to gravity. The feeding element is advantageously decoupled from the brewing chamber container. This ensures that, during operation of the shaking apparatus, only the brewing chamber container coupled thereto is caused to vibrate but not the feeding element. An unimpeded discharge of the coffee powder from the discharge opening of the feeding element into the brewing chamber container can thereby be ensured without vibrations interfering with the discharge of the coffee powder.

The brewing chamber can comprise a cylindrical brewing chamber container which is integrated into the coffee machine as a component of the brewing chamber. Such a brewing chamber container integrated into a fully automatic coffee machine comprises, for example, a tubular main body with a filling opening arranged at the top and an outlet opening opposite thereto. A movable first tamper is arranged to be inserted into the outlet opening and, in its inserted position, to form a bottom of the brewing chamber. A second tamper can be arranged to be inserted from above through the filling opening of the brewing chamber container. In order to fill the brewing chamber thus formed with coffee powder and during brewing of the coffee powder to produce a coffee beverage, the first tamper is in its inserted position and forms the bottom of the brewing chamber on which the introduced amount of coffee powder rests. After a desired amount of coffee powder has been introduced, the second tamper can be pressed through the filling opening of the brewing chamber container in order to compress the coffee powder located therein. After compression of the coffee powder, the second tamper can be removed from the brewing chamber container, and the coffee powder compressed in the brewing chamber container is brewed with hot water. The coffee beverage produced in this way flows out of the brewing chamber through a coffee outlet and can be poured into a cup in portions. After completion of the brewing process, the first tamper located in the outlet opening can be removed from the brewing chamber container in order to remove the used coffee powder from the brewing chamber container, wherein, in order to eject the wet coffee powder cake, the second tamper can again be inserted from above through the filling opening of the brewing chamber container, in order to push the used coffee filter cake out of the brewing chamber container through the outlet opening.

In order to prevent the feeding element of the feeding apparatus from interfering with the compression of the introduced coffee powder, it is expedient if the brewing chamber container and the feeding element are pivotable relative to one another. For example, the feeding element can be pivotably mounted above the brewing chamber container. As a result, the feeding element can be pivoted away from the brewing chamber container after the coffee powder has been completely introduced into the brewing chamber container, so that the second tamper can be inserted from above into the filling opening of the brewing chamber container without any impediment, in order to compress the coffee powder. In this case, it is also possible to mount the brewing chamber container pivotably relative to the stationary feeding element. In this embodiment, it is preferred to transfer a pivoting movement of the brewing chamber container from the shaking apparatus to the brewing chamber container. As a result, the pivoting movement of the brewing chamber container can be triggered by the shaking apparatus.

The shaking apparatus of the device expediently has an electrically driven motor, in particular an eccentric or an unbalanced motor. The electrically driven motor of the shaking apparatus can be in the form of an unbalanced motor for example, that drives an unbalanced mass. The motor can be integrated into the coffee machine and may be driven electrically in a simple manner, since an electrical supply is present anyway in a fully or semi-automatic coffee machine, for example for the pumps for supplying the brewing water and for an electric heater for heating the brewing water. In an expedient embodiment, the shaking apparatus can have an alternating and rotationally reciprocating shaft which is connected in the radial direction of the shaft to the brewing chamber in order to transfer the rotational movements of the shaking apparatus to the brewing chamber.

The brewing chamber is expediently coupled to the shaking apparatus in such a way that the shaking movements of the shaking apparatus are transferred to the brewing chamber in two directions orthogonal to one another. For example, in the case of a cylindrical embodiment of the brewing chamber container, the brewing chamber can move in the radial or axial direction. In this case, it is also possible to generate a superimposed shaking movement both in the radial direction and in the axial direction. Transfer of the vibration transferred from the shaking apparatus to the brewing chamber both in the radial and in the axial direction improves on the one hand the homogeneous distribution of the coffee powder introduced into the brewing chamber container and ensures on the other hand a pre-compression, which, in conjunction with the second tamper inserted into the filling opening of the brewing chamber container for compressing the coffee powder, enables a homogeneous density distribution of the coffee powder compressed in the brewing chamber.

In order to control the vibrational movements which are transferred from the shaking apparatus to the brewing chamber, the shaking apparatus is expediently coupled to a control unit of the coffee machine. The shaking apparatus can be controlled by the control unit in such a way that it causes the brewing chamber to vibrate while the feeding apparatus conducts coffee powder into the brewing chamber container. It is also possible for the control unit to put the shaking apparatus into operation after completion of the filling process so that the coffee powder conducted into the brewing chamber container by the feeding apparatus is evened out in the brewing chamber by the vibrations transferred from the shaking apparatus to the brewing chamber after completion of the filling process.

The amplitude and/or the frequency of the shaking movement transferred from the shaking apparatus to the brewing chamber can preferably be adjusted. This adjustment expediently takes place via the control unit of the coffee machine, wherein an operator can specify desired settings for the amplitude and/or the frequency of the shaking movement of the shaking apparatus at an operator interface. This makes it possible to adapt the even distribution and compression of the coffee powder in the brewing chamber to different compositions and parameters of the coffee powder, for example to the grinding degree of the coffee powder or the degree of roasting of the coffee beans from which the coffee powder has been produced by grinding.

### BRIEF DESCRIPTION OF THE DRAWING

These and other advantages and features will be apparent from the exemplary embodiments described in more detail below with reference to the accompanying drawing figures. Including in the drawing are the following figures:

FIGS. 1A, 1B, and 1C are schematic diagrams of a device for feeding coffee powder into a brewing chamber of a coffee machine, the device being shown:

in FIG. 1A, during introduction of the coffee powder into a brewing chamber container of the brewing chamber,

in FIG. 1B, the brewing chamber coupled to a shaking apparatus during the introduction of the coffee powder, and

in FIG. 1C, the brewing chamber container during compression of the introduced coffee powder with a second tamper inserted into the brewing chamber container;

FIGS. 2A and 2B are diagrams of an exemplary embodiment for coupling a shaking apparatus to the brewing chamber;

FIG. 2A: the device of FIGS. 1A, 1B, and 1C in a side view; and

FIG. 2b: the device of FIGS. 1A, 1B, and 1C in a view from above.

### DETAILED DESCRIPTION

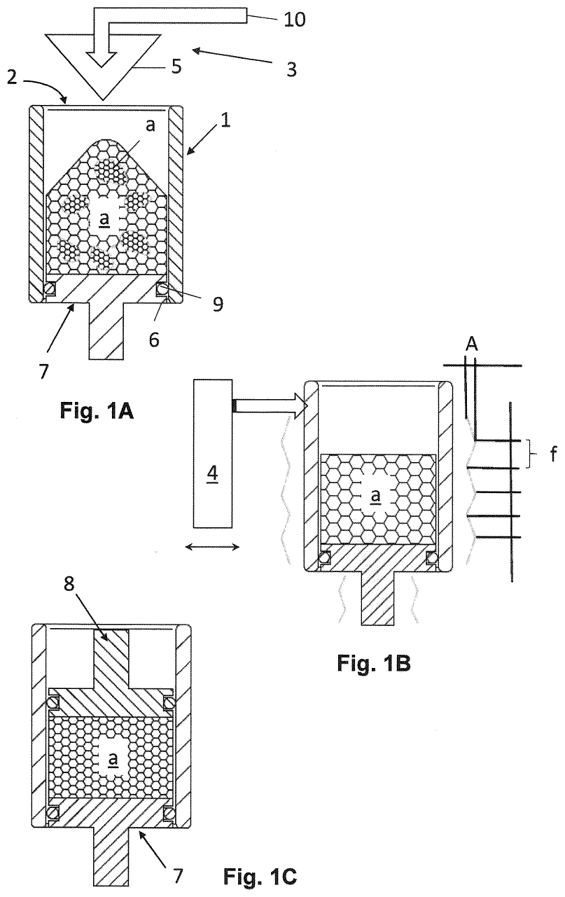

FIGS. 1A, 1B, and 1C show a device for feeding coffee powder into a brewing chamber of a coffee machine. The brewing chamber can be a brewing chamber container 1 integrated into a coffee machine, for example a fully automatic coffee machine.

The exemplary embodiment shown in FIGS. 1A, 1B, and 1C is a brewing chamber which is integrated or can be integrated into a fully automatic coffee machine and has a brewing chamber container 1 in the form of a tubular section with an upper filling opening 2 and an outlet opening 6 opposite thereto. Inserted into the outlet opening 6 is a movable first tamper 7 which, in its inserted position shown in FIG. 1A, forms a bottom of the brewing chamber 1. Seals 9 are provided for sealing the bottom relative to the tubular wall of the brewing chamber container 1. A feeding element 5 of a feeding apparatus 3 for feeding the coffee powder (a) is arranged above the filling opening 2. The feeding element 5 can be a funnel, as indicated in FIG. 1A. The feeding element can also be designed as a filling tube or a filling hose. The feeding apparatus 3 is connected via a connecting line 10 to a grinding apparatus not shown here. The grinding apparatus can be a mill integrated into the coffee machine for grinding coffee beans. The coffee powder produced by the grinding apparatus is conducted through the feed line 10 and the feeding element 5 through the filling opening 2 into the brewing chamber container 1, whereby the coffee powder trickles out of the feeding element 5 and into the brewing chamber container 1 due to gravity. During the filling process, a heap of coffee powder (a) is formed as indicated in FIG. 1A.

In order to prevent the coffee powder (a) introduced into the brewing chamber container 1 from accumulating in the form of a coffee powder heap, a shaking apparatus 4 is mechanically coupled to the brewing chamber. The shaking apparatus can be, for example, an electrically driven eccentric motor or an electric unbalanced motor, which drives an unbalanced mass in the motor. The shaking apparatus 4 generates shaking movements with a predetermined amplitude A and a predetermined frequency f. These shaking movements are transferred to the brewing chamber 1 by the mechanical coupling of the shaking apparatus 4, which is indicated in FIG. 1B by the arrow shown between the shaking apparatus 4 and the brewing chamber 1. Owing to the transfer of the shaking movements of the shaking apparatus 4 to the brewing chamber 1, the brewing chamber 1 also executes vibrations at the predetermined amplitude A and the predetermined frequency f.

In an expedient exemplary embodiment, the shaking movement of the shaking apparatus is transferred to the brewing chamber 1 in an axial direction of the brewing chamber container 1. In a further exemplary embodiment, the shaking movements of the shaking apparatus 4 are transferred to the brewing chamber 1 in two mutually orthogonal directions; that is to say, for example, in the radial and in the axial direction of the cylindrical brewing chamber container 1.

In order to control the shaking movements transferred from the shaking apparatus 4 to the brewing chamber 1, the electrically driven motor of the shaking apparatus 4 is coupled to a control unit. In this case, the control unit can expediently be the central control unit of the coffee machine. The amplitude and the frequency of the shaking movements can be controlled via this control unit. The control unit preferably comprises an operator interface via which an operator of the coffee machine can input the desired amplitude A and the desired frequency f of the shaking movements or select them from a series of predetermined values. The control unit accordingly controls the shaking apparatus 4 in accordance with the input values for the amplitude A and the frequency f.

The control unit is expediently configured in such a way that the shaking apparatus 4 is put into operation during the introduction of coffee powder into the brewing chamber 1 by means of the feeding apparatus 3 and is switched off after completion of the filling process. However, it is also possible for the shaking apparatus 4 to be put into operation only after the completion of the filling process, in order to cause the brewing chamber 1 coupled to the shaking apparatus 4 to vibrate. Due to the vibrations transferred to the brewing chamber 1, the coffee powder (a) is evenly distributed in the brewing chamber 1, either already during the filling process and/or after the filling process, resulting in a flat, horizontal leveling of the coffee powder (a) in the brewing chamber 1, as shown in FIG. 1B.

After the introduction and the levelling of the introduced amount of the coffee powder (a) into the brewing chamber 1, a second tamper 8 is pressed from above through the filling opening 2 of the brewing chamber container 1, in order to compress the introduced amount of coffee powder (a). In order that the feeding apparatus 3 does not impede the insertion movement of the second tamper 8 into the brewing chamber container 1, the feeding apparatus 3 is pivotable so that the feeding apparatus 3 can be pivoted away from the filling opening 2 when the second tamper 8 is inserted into the brewing chamber container 1.

A feed line, not shown here, for feeding hot water is arranged in the second tamper 8. After the coffee powder (a) has been compressed, hot water is conducted into the brewing chamber container 1 via this feed line in order to brew the introduced coffee powder (a). The coffee beverage produced thereby can flow out of the brewing chamber through a coffee outlet, also not shown here, and be poured into a cup.

After completion of the brewing process and removal of the coffee beverage produced thereby, the lower, first tamper 7 is moved out of the brewing chamber container 1, and the wet coffee powder cake of the used coffee powder located in the brewing chamber container 1 can be pressed downward out of the outlet opening 6 by a further movement of the upper, second tamper 8 in order to clear the brewing chamber 1 for the next brewing process for producing a coffee beverage.

Thereafter, the bottom of the brewing chamber 1 is closed again by inserting the (lower) first tamper 7 into the outlet opening 6 of the brewing chamber container 1, so that a predetermined amount of coffee powder can be metered into the brewing chamber container 1 again and evenly compressed in the manner described above for the next brewing process.

In order to ensure that the entire amount of coffee powder provided by the grinding apparatus can be conducted without loss via the feeding apparatus 3 into the brewing chamber container 1, the feeding element 5 is preferably mechanically decoupled from the brewing chamber container 1. This ensures that, during operation of the shaking apparatus 4, the vibrations are only transferred to the brewing chamber but not to the feeding element 5 or the feeding apparatus 3.

The shaking movements transferred by the shaking apparatus 4 during and/or after the introduction of the coffee powder (a) into the brewing chamber container 1 lead to an even distribution of the introduced amount of the coffee powder (a) in the brewing chamber 1 and ensure a largely flat, horizontal surface of the introduced amount of coffee powder. As a result, when the introduced coffee powder (a) is subsequently compressed by the upper, second tamper 8, an even and homogeneous compression of the coffee powder (a) in the brewing chamber 1 can be ensured. The introduced and compressed coffee powder has a homogeneous density distribution over the entire volume of the introduced coffee powder. A homogeneous distribution possible and an even density of the introduced amount of the coffee powder has a positive influence on the quality of the coffee beverage produced, since a larger effective brewing volume can be utilized when brewing the coffee powder distributed evenly in the brewing chamber 1.

The desired homogeneous distribution of the coffee powder in the brewing chamber 1 can be adapted to the properties of the coffee powder used, such as its grinding or roasting degree, by the preferably enabled adjustment of the amplitude and/or the frequency of the shaking movements which are transferred from the shaking apparatus 4 to the brewing chamber 1. The properties of the coffee powder likewise have a considerable influence on the quality and the taste of the coffee beverage produced, which can still be optimized using the devices described herein.

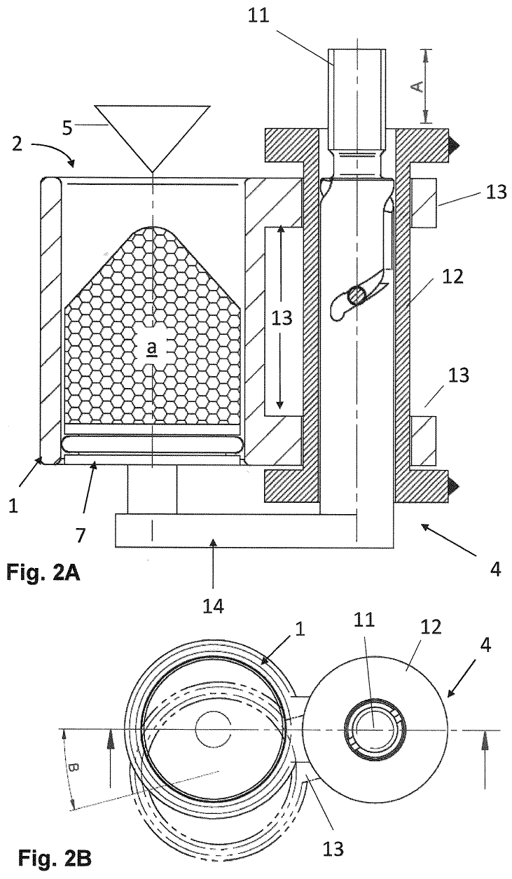

FIGS. 2A and 2B show an exemplary embodiment for coupling a shaking apparatus 4 to a brewing chamber 1. The shaking apparatus 4 comprises a shaft 11 which is rotatably mounted in a sleeve-shaped bearing housing 12 and is coupled to a motor (not shown here). The shaft 11 is caused to be displaced axially in the bearing housing 12. In addition, the motor can transfer alternating rotational movements; that is to say, radial reciprocating movements, for generating shaking movements to the shaft 11. At the lower end of the shaft 11 there is a connecting part 14 which connects the shaft 11 to the lower tamper 7. In the position shown in FIG. 2A, the lower tamper 7 is inserted into the outlet opening 6 of the brewing chamber container 1, in order to form a bottom of the brewing chamber 1. Radially projecting flanges 13 are arranged on the outer circumference of the brewing chamber container 1 and surround the bearing housing 12 and are mounted in a rotationally movable manner on the outer circumference of the bearing housing 12.

The shaft 11 can be displaced upward and downward in the axial direction in the stationary bearing housing 12. The motor coupled to the shaft 11 is preferably actuated by a control unit in such a way that it can trigger an axial displacements of the shaft 11 relative to the bearing bushing 12. In an exemplary embodiment, in addition to the axial displacements of the shaft 11 relative to the bearing housing 12, also a periodic rotational movement of the shaft 11 can be actuated by the control unit.

In the case of a transfer of reciprocating rotational movements of the shaft 11 relative to the stationary bearing housing 12, the rotational movements of the shaft 11 are transferred as vibrational movements to the brewing chamber container 1 via the connecting part 14. The brewing chamber container 1 is caused to vibrate thereby. The axial movement of the shaft 11 in the bearing housing 12 is transferred to the brewing chamber container 1 via the connecting part 14. When the shaft 11 is alternately periodically moved upward and downward in the axial direction, this movement of the shaft 11 is transferred to the brewing chamber container 1 as an axial vibrational movement.

FIG. 2B shows an exemplary embodiment in which periodic rotational movements are transferred from the shaking apparatus 4 to the brewing chamber 1 within a rotational angle B.

In the embodiment shown in FIGS. 2A and B, the coupling of the lower tamper 7 via the connecting part 14 to the shaft 11 can also be used to move the lower tamper 7 into the outlet opening 6 and out of the outlet opening 6. In order to move the lower tamper 7 out of the outlet opening 6 of the brewing chamber container 1, the shaft 11 can be displaced downward in the bearing housing 12 in the axial direction. In order to move the tamper 7 out of the outlet opening 6 and away from the outlet opening 6, the shaft 11 can then be rotated by a predetermined angle. In this case, the rotational angle is expediently adjusted to be large enough for the removed first tamper 7 to be pivoted completely away from the outlet opening 6. By pivoting away the lower first tamper 7, the coffee powder cake of used coffee powder (a) located in the brewing chamber container 1 after completion of a brewing process can be ejected from the brewing chamber without any impediment by means of the upper second tamper 8.

What is claimed is:

1. A device for feeding coffee powder into a brewing chamber of a coffee machine, the device comprising:
a brewing chamber comprising a cylindrical brewing chamber container having a filling opening for receiving coffee powder to be brewed in the brewing chamber;
a feeding apparatus for feeding the coffee powder through the filling opening into the brewing chamber container; and
a shaking apparatus coupled to the brewing chamber in order to cause the brewing chamber to vibrate during and/or after the coffee powder has been fed filled into the brewing chamber,
wherein the shaking apparatus comprises an axially reciprocating shaft, which is coupled to the brewing chamber in order to transfer axial movements of the shaft to the brewing chamber.

2. The device according to claim 1, wherein the feeding apparatus comprises a feeding element in the form of a funnel or a filling tube via which the coffee powder can be introduced into the brewing chamber through the filling opening, and wherein the feeding element is decoupled from the brewing chamber container.

3. The device according to claim 1, wherein the shaking apparatus causes the brewing chamber to vibrate in an axial direction during the introduction of the coffee powder.

4. The device according to claim 1, wherein the shaking apparatus causes the brewing chamber to vibrate in an axial direction and in a radial direction of the brewing chamber container during the introduction of the coffee powder.

5. The device according to claim 1, wherein the shaking apparatus is coupled to and controlled by a control unit, such that the shaking apparatus causes the brewing chamber to vibrate while the feeding apparatus conducts the coffee powder into the brewing chamber or after the coffee powder has been filled into the brewing chamber.

6. The device according to claim 5, wherein at least one of the amplitude or the frequency of a shaking movement transferred by the shaking apparatus to the brewing chamber can be adjusted via the control unit.

7. The device according to claim 1, wherein the brewing chamber container comprises an outlet opening which is generally opposite the filling opening.

8. The device according to claim 7, wherein the brewing chamber comprises a movable first tamper which is sized and shaped to be inserted into and removed from the outlet opening of the brewing chamber container, and wherein, in an inserted position, the first tamper forms a bottom of the brewing chamber.

9. The device according to claim 1, wherein the brewing chamber comprises a movable second tamper which is sized and shaped to be inserted into the filling opening of the brewing chamber container, and wherein the second tamper is coupled to a control unit which presses the second tamper into the filling opening after a predetermined amount of the coffee powder has been introduced into the brewing chamber container, in order to compress the introduced coffee powder by means of the second tamper.

10. The device according to claim 1, wherein the brewing chamber comprises a coffee outlet through which coffee produced in the brewing chamber by brewing the coffee powder with hot water can flow out of the brewing chamber.

11. The device according to claim 1, wherein the feeding apparatus is coupled to a grinding apparatus, and wherein the grinding apparatus produces the coffee powder by grinding coffee beans.

12. The device according to claim 1, wherein the shaking apparatus comprises an electrically driven motor.

13. The device according to claim 1, wherein the shaking apparatus causes the brewing chamber to vibrate in two mutually orthogonal directions.

14. The device according to claim 2, wherein the feeding element of the feeding apparatus and the brewing chamber container can be pivoted relative to one another.

15. The device according to claim 2, wherein the brewing chamber container can be pivoted relative to the stationary feeding element, and wherein a pivoting movement of the brewing chamber container is triggered by the shaking apparatus.

16. A brewing chamber for a coffee machine, the brewing chamber comprising:
a brewing chamber container comprising a filling opening for receiving coffee powder and an outlet opening which is opposite the filling opening;
a feeding apparatus for feeding the coffee powder through the filling opening into the brewing chamber container;
a movable first tamper sized and shaped to be inserted into and removed from the outlet opening of the brewing chamber container, wherein the first tamper forms a bottom of the brewing chamber when inserted in the brewing chamber container; and
a shaking apparatus comprising a shaft, which is connected to the first tamper and is coupled to a motor,
wherein the motor imparts an alternately periodical movement of the shaft in an axial direction during and/or after the coffee power has been fed into the brewing chamber and while the first tamper is inserted in the brewing chamber container.

17. The brewing chamber according to claim 16, wherein the brewing chamber comprises a movable second tamper which can be inserted into the filling opening of the brewing chamber container, wherein the second tamper is coupled to a control unit which presses the second tamper into the filling opening after a predetermined amount of coffee powder has been introduced into the brewing chamber container, in order to compress the introduced coffee powder with the second tamper.

18. The brewing chamber according to claim 16, wherein the shaft is mounted in a bearing housing and a connecting part is disposed between the shaft and the first tamper, wherein the motor imparts an axial displacement of the shaft in the bearing housing and the axial displacement of the shaft is transferred from the shaft via the connecting part to the first tamper.

19. A coffee machine comprising a brewing chamber, a coffee powder feeding apparatus, and a shaking apparatus,
wherein the brewing chamber comprises:
a cylindrical brewing chamber container having a filling opening for receiving coffee powder to be brewed in the brewing chamber and an outlet opening which is opposite the filling opening; and
a movable first tamper inserted into the outlet opening of the brewing chamber to form a bottom of the brewing chamber,
wherein the feeding apparatus is feeding coffee powder through the filling opening into the brewing chamber, and
wherein the shaking apparatus comprises a shaft, which is coupled to the first tamper and to a motor, wherein the motor causes the shaft to move alternately periodically in an axial direction of the shaft while the feeding apparatus is feeding the coffee powder into the brewing chamber and/or after the coffee powder has been fed into the brewing chamber.

20. The coffee machine according to claim 19,
wherein the feeding apparatus comprises a feeding element in the form of a funnel or a filling tube,
wherein the feeding element is arranged above the filling opening,
wherein the feeding element is decoupled from the brewing chamber container, and
wherein the brewing chamber container is pivotable relative to the feeding element.
